(19) United States
(12) Patent Application Publication
(10) Pub. No.: US 2021/0048789 A1
(43) Pub. Date: Feb. 18, 2021

(54) Control Device

(71) Applicant: Euchner GmbH + Co. KG, Leinfelden-Echterdingen (DE)

(72) Inventors: Fabian Keller, Aichtal (DE); Dimitri Denk, Boblingen (DE)

(21) Appl. No.: 16/993,311

(22) Filed: Aug. 14, 2020

(30) Foreign Application Priority Data
Aug. 16, 2019 (EP) 19192085.9

(51) Int. Cl. G05B 19/05

(52) U.S. Cl. CPC G05B 19/058; G05B 19/054; G05B 19/056

(57) ABSTRACT

A control device (7) for a system controlled by a controller with an evaluation unit (9) and at least one acquisition unit (17a, 17b) that is connected to the evaluation unit (9). Depending on input values that are input in the acquisition unit (17a, 17b), an operating mode selection can be performed and/or an access authorization can be granted. Output values generated in this manner can be output to the controller via an output stage (8).

### CROSS REFERENCE TO RELATED APPLICATIONS

This application claims the priority of EP 19192085.9 filed on 2019 Aug. 16; this application is incorporated by reference herein in its entirety.

### BACKGROUND

The invention relates to a control device for a system controlled by a controller.

Such systems typically form safety systems that are used in the area of machine safety.

Such a safety system generally comprises a control system that controls a machine, the term machine also comprising equipment and similar. The machine can be a source of hazards for persons within a hazard zone.

This hazard zone is monitored as a safety measure, the machine having a safety controller as a control system for controlling and monitoring safety-relevant functions.

For example, the hazard zone of the machine is secured with a safety cover or enclosure. There is then a safety door or flap in the enclosure. Here monitoring is performed such that a person can only enter the hazard zone through the safety door when it is not possible for the machine to present a hazard.

As an additional safety element, an access system can be provided which is connected to the control system, i.e. the security controller, by means of which a controlled access to safety-related zones, and hazard zones in particular, is monitored. Such an access system can be formed, for example, by an electronic key system. This electronic key system comprises a key insert and at least one key associated with it.

The evaluation of the data from the access system must occur in the safety controller. A corresponding programming of the safety controller is necessary for this purpose. Moreover, in such safety systems, multiple operating modes are possible. Depending on the operating mode, the machine may be operated differently and/or the monitoring function of the safety system may be designed differently.

One problem with such safety systems is that, due to statutory provisions, a switching of the operating mode must be restricted to authorized persons. Moreover, a safety level for the switching is required that cannot be achieved with just any conventional systems, but rather requires the use of safety technology.

Therefore, in known safety systems, their safety controller is incorporated into the operating mode selection. As such, a corresponding programming of the safety controller is also necessary for the operating mode selection.

Such programming of a safety controller is generally associated with significant effort.

Typical safety controllers, however, especially for NC machines, are only equipped with small memories and do not permit such extensive programming. Moreover, for this purpose a safety technical, i.e. error-checked, program must be created that has to be extensively checked and validated.

### SUMMARY

The invention relates to a control device (7) for a system controlled by a controller with an evaluation unit (9) and at least one acquisition unit (17a, 17b) that is connected to the evaluation unit (9). Depending on input values that are input in the acquisition unit (17a, 17b), an operating mode selection can be performed and/or an access authorization can be granted. Output values generated in this manner can be output to the controller via an output stage (8).

### DETAILED DESCRIPTION

The invention seeks to solve the problem of assigning access authorizations and/or operating modes for systems, especially safety systems, in the most safe, simple and flexible manner possible.

The features of claim 1 are provided to solve this problem. Advantageous embodiments and appropriate further developments of the invention are described in the dependent claims.

The invention relates to a control device for a system, controlled by a controller, with an evaluation unit and at least one acquisition unit that is connected to the evaluation unit. Depending on input values input into the acquisition unit, in the evaluation unit an operating mode selection can be performed and/or an access authorization can be granted. Output values generated in this manner can be output to the controller via an output step.

The basic concept behind the invention is that the control device forms an autonomous unit, separated and independent from the controller of the system, with which on the one hand, the function of an access control system, and/or on the other hand, the function of an operating mode selection system, is realized.

Since according to the invention these functionalities are transferred out of the controller of the system, no arrangements or dispositions for these functionalities have to be provided in the controller. In particular, there is no need for extensive programming of the controller to realize such functionalities. Rather, a selected operating mode or also, granted access authorizations, may be supplied to the controller, as results of the evaluation in the control device, in the form of output values from the controller, where they can be directly used, without additional evaluations.

This advantage is especially brought to bear when the system is a safety system that is controlled by a safety controller.

In this case, there is no need for a laborious creation of programs which are error-checked and to be validated since the software required to grant access authorizations and/or the selection of operating modes is completely transferred to the control device.

To fulfill the safety requirements, i.e. to ensure a failsafe access control system and a failsafe operating mode selection, the evaluation unit of the control device has a failsafe, especially redundant, structure, which is advantageously realized in that the evaluation unit has a dual-channel design.

Furthermore, the output stage is then configured as a safe output stage via which a safe signal output occurs to a safety controller controlling a safety system.

In the simplest case, the safe output stage is composed of a number of digital outputs.

It is especially advantageous for the safe output stage to form a safe bidirectional interface. It is especially expedient for the safe output stage to be designed in the form of a safety bus system.

Examples of such safety bus systems are Profisafe, IO Link Safety or CIP Safety.

According to an especially advantageous embodiment, at least one acquisition unit is provided, which is a component of an access system.

The term access system comprises physical access systems that, for example, regulate and control access to hazard zones of machines and equipments. Furthermore, the term access system also comprises systems that control access to secured, especially safety-related datasets, such as process or access data, access authorizations and similar, for example.

In particular, the at least one acquisition unit forming an access system is a reader unit that is designed for reading signals of a transponder.

The reader unit forming the acquisition unit and the transponders assigned to it form an electronic key system. In general, in such an electronic key system, multiple transponders can be assigned to a reader unit, in which various data is stored.

Data fields are stored in the transponders, the data fields being preferably secured with checksums. If a transponder is in the reading region of the reader unit, the data fields are read into the reader unit as input values and checked for validity. If these are valid input values, an access or admission authorization is released in the evaluation unit.

In particular, it is possible to provide various authorization levels. For example, various data fields that define various authorization levels can be stored in the individual transponders. Depending on the authorization levels, a release of access or admission corresponding to the authorization level occurs in the evaluation unit.

A user with a low authorization level can therefore only get access to a hazard zone through a safety door if an equipment located there is at a standstill. Conversely, a user with a high authorization level may get access to the equipment even while the equipment is running, such as in order to perform maintenance work.

Advantageously, the at least one acquisition unit is connected to the evaluation unit via a wired or touchless interface.

For example, these interfaces can be implemented as RS485, WiFi, Ethernet, Bluetooth or CAN Bus interfaces.

An essential advantage of these interfaces is that the spatial position of the respective acquisition unit is largely independent from the evaluation unit of the control device, such that flexible adaptation to various applications is provided.

This way, in an especially advantageous manner, complex applications may also be realized, in which multiple acquisition systems forming access systems are connected to the evaluation unit of the control device.

For example, the individual access systems, especially electronic key systems, can be used for access control on safety doors that form access points to hazard zones. In contrast to known safety devices, the evaluation of signals from the individual acquisition units can take place in a central evaluation unit of the control device, by which a significant efficiency effect is achieved.

In this case, the access systems can be spatially distributed. It is also possible to use different access systems. In this way, different reader units of electronic key systems that work at various frequencies can be used.

Furthermore, acquisition units for reading various physical signals are possible using the widest range of technologies. These can be used in parallel.

According to an advantageous embodiment, at least one input/output unit is connected to the acquisition unit.

The input/output unit can be formed by a PC or also by a touch panel, for example.

In particular, the input/output unit can be used by a user to input a desired operating mode of the system, especially of the safety system.

The operating mode that is input is checked for validity in the evaluation unit of the control device and read back by the evaluation unit to the input/output unit, where the user acknowledges the operating mode that was input. A safe operating mode selection is therefore ensured with the evaluation unit of the control device, especially when the evaluation unit has a failsafe redundant design.

In particular, an access system connected to the evaluation unit of the control device may also be co-incorporated into the operating mode selection in that, depending on input values of the access system, an authorization to select an operating mode is released in the evaluation unit, after which a user can then input the desired operating mode in the input/output unit.

The operating mode that was checked and released in the control device in this manner is output as an output value to the controller via the output stage, especially the safe output stage to the safety controller, such that the controller or safety controller can immediately begin operation in the selected operating mode.

The functionality of the control device may be extended such that the or multiple acquisition units are designed for a data transfer.

For example, the electronic key systems may be used to perform a data transfer.

User data, configurations, process data or backup data, for example, can be read into the evaluation unit of the control device. So-called blacklists or whitelists can be loaded into the evaluation unit, blocked user access credentials being stored in the blacklists and enabled user access credentials are stored in the whitelists.

Finally, with the data transfer, it is possible to load a firmware into the evaluation unit in order to realize an application-specific evaluation.

According to an advantageous further development, the evaluation unit has at least one interface for connecting additional components.

Such additional components may be operating elements, limit switches, warning lights and similar. Since these additional components no longer have to be connected to the controller, the load on it can be further reduced.

### BRIEF DESCRIPTION OF THE DRAWINGS

The invention is explained below with reference to the drawings. They show:

FIG. 1: A schematic depiction of a safety system for securing a hazard zone.

FIG. 2: An exemplary embodiment of the control device according to the invention for the safety system from FIG. 1.

### DETAILED DESCRIPTION OF THE PREFERRED EMBODIMENTS

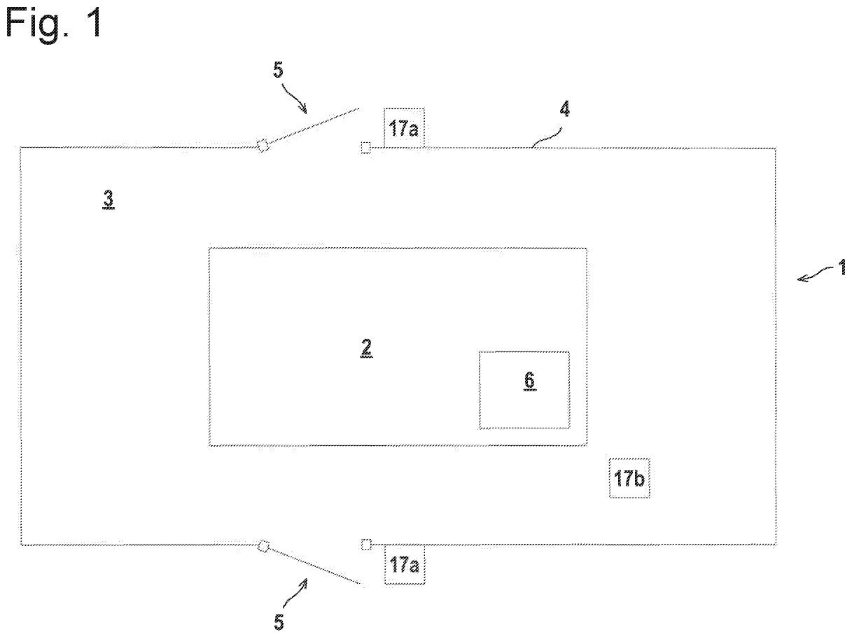

FIG. 1 shows schematically a safety system 1 for safe operation of a machine 2. The machine 2 can be a source of hazards, especially for persons. Accordingly, a hazard zone 3 around the machine 2 is secured with an enclosure 4. In the enclosure 4, two safety doors 5 are provided through which persons can get access to the hazard zone 3.

A safety controller 6 that controls the operation of the machine 2 is provided as an essential component of the safety system 1. Safety switches used to monitor whether the safety doors 5 are closed or not are typically provided as additional components of the safety system 1. The safety controller 6 controls the operation of the machine 2, especially depending on the signals generated by the safety switch.

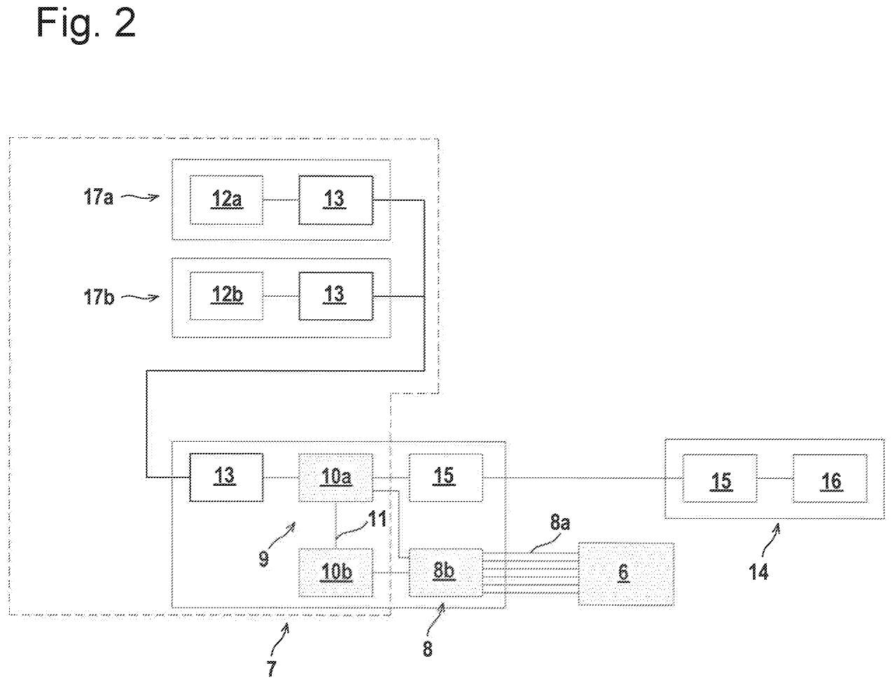

FIG. 2 shows an exemplary embodiment of the control device 7 according to the invention that can be used for the safety system 1 from FIG. 1.

The control device 7 forms an independent unit from the safety controller 6 of the safety system 1.

The control device 7 can be connected to the safety controller 6 via a safe output stage 8. In the present case, the safe output stage 8 has a number of digital outputs 8a and an output circuit 8b for controlling the digital outputs 8a. In the present case, the output circuit 8b is formed by a one-out-of-N circuit that ensures that only one digital output 8a is ever active, through which safe output signals can be output to the safety controller 6.

Alternatively, the safe output stage 8 can also be formed by a safety bus system. Profisafe, IO Link Safety or CIP Safety are examples of this.

The safe output signals are generated in an evaluation unit 9 of the control device 7. The safe output stage 8 is connected to the evaluation unit 9 for this purpose.

In the present case, the evaluation unit 9 of the control device 7 has a failsafe, redundant design. In this case, the evaluation unit 9 has two computing units 10a, 10b that can respectively be formed by a processor. The computing units 10a, 10b of the evaluation unit 9 are connected by data lines 11 via which a bidirectional data exchange can occur between the computing units 10a, 10b, especially for a mutual monitoring of the computing units 10a, 10b.

In principle, the control device 7 can also have a single channel evaluation unit 9. The control device 7 has a preset number of acquisition units 17a, 17b connected to the evaluation unit 9.

As acquisition units 17a, 17b in the present case, reader units 12a, 12b are provided, which are components of an access system in the form of an electronic key system. The two reader units 12a, 12b are typically composed of a CPU and an antenna. Multiple transponders (not shown) are assigned to each reader unit 12a, 12b to form an electronic key system.

In the present case, one of the electronic key systems respectively forms an access system for one of the safety doors 5 of the safety system 1 from FIG. 1.

In particular, the electronic key system can also be designed as an access system for a safety door 5. For example, an authentication in the form of encodings that define the conditions under which the safety doors 5 may be opened with the respective transponder, thereby granting a person access to the hazard zone 3, can be stored in each transponder.

The reader units 12a, 12b can also be used for a data transfer, especially in order to transfer user data, configurations, backup data, process data or also firmware into the evaluation unit 9.

Each reader unit 12a, 12b is connected to the evaluation unit 9 through an interface 13. In the present case, the interfaces 13 are implemented as RS485 interfaces. In general, wired or touchless interfaces 13 are possible. These are made such that the reader units 12a, 12b can be arranged separate in space from the evaluation unit 9. In this way, at the safety system 1 from FIG. 1, a reader unit 12a, 12b can respectively be arranged in the region of one of the safety doors 5 from a central evaluation unit 9.

The reader units 12a, 12b may be designed identically or differently. In general, more than two reader units can also be connected to the evaluation unit 9.

In the dual-channel embodiment of the evaluation unit 9, as shown in FIG. 2, the RS485 interface is connected to one of the computing units 10a of the evaluation unit 9.

In general, other interfaces 13 are also possible, such as WiFi, Ethernet, Bluetooth or CAN Bus, for example.

The transponder signals acquired with the reader units 12a, 12b are evaluated in the evaluation unit 9, access authorizations being checked and released in this evaluation. The safe output signals generated in this way in the evaluation unit 9 are provided to the safety controller 6 via the safe output stage 8.

Furthermore, an input/output unit, which in the present case is formed by a PC 14 (personal computer), is connected to the evaluation unit 9. The connection is realized via a communication interface 15 that can be formed by an RS485, USB, Profinet interface and similar. In general, the control device 7 can have multiple different communication interfaces 15.

In general, the control device 7 can also have interfaces 13 for connecting additional components such as control elements, limit switches, warning lights and similar.

The PC 14 has input/output means 16, such as keyboards, displays, etc. in the known manner.

In the present case, the input/output unit, i.e. the PC 14, is used for an operating mode selection. To do so, a user first inputs authentication data in the input/output unit, which authentication data may be formed by a password in the simplest case. The input of biometric data is also possible.

The user then inputs the desired operating mode into the input/output unit, which operating mode is then checked for validity in the evaluation unit 9. To do so, an authorization that is input via a reader unit 12a, 12b and released in the evaluation unit 9 can be used for an operating mode selection, in particular. The checked operating mode is then read back into the input/output unit by the evaluation unit 9, where the user checks whether the selection of the operating mode was correct.

In this way, a failsafe operating mode selection is performed completely in the control device 7. The selected operating mode is then output to the safety controller 6 via the safe output stage 8.

### LIST OF REFERENCE NUMERALS

(1) safety system
(2) machine
(3) hazard zone
(4) enclosure
(5) safety door
(6) safety controller
(7) control device
(8) output stage
(8a) digital output
(8b) output circuit
(9) evaluation unit
(10a, 10b) computing unit
(11) data line
(12a, 12b) reader unit
(13) interface
(14) PC
(15) communication interface
(16) input/output means
(17a, 17b) acquisition unit

1. A control device (7) for a system controlled by a controller with an evaluation unit (9) and at least one acquisition unit (17a, 17b) that is connected to the evaluation unit (9), wherein, depending on input values input in the acquisition unit (17a, 17b), an operating mode selection can be performed and/or an access authorization can be granted in the evaluation unit (9) and output values generated in this manner can be output to the controller via an output stage (8).

2. The control device (7) according to claim 1, characterized in that the evaluation unit (9) has a dual-channel design.

3. The control device (7) according to claim 1, characterized in that the output stage (8) is designed as a safe output stage (8) via which a safe signal output to a safety controller (6) controlling a safety system (1) occurs.

4. The control device (7) according to claim 3, characterized in that the safe output stage (8) is designed in the form of digital outputs (8a) or in the form of a safety bus system.

5. The control device (7) according to claim 1, characterized in that at least one acquisition unit (17a, 17b), which is a component of an access system, is provided.

6. The control device (7) according to claim 5, characterized in that the at least one acquisition unit (17a, 17b) forming an access system is a reader unit (12a, 12b) that is designed for reading signals of a transponder.

7. The control device (7) according to claim 1, characterized in that the at least one acquisition unit (17a, 17b) is connected to the evaluation unit (9) via a wired or touchless interface (13).

8. The control device (7) according to claim 5, characterized in that multiple acquisition units (17a, 17b) are provided that form different and/or spatially separated access systems.

9. The control device (7) according to claim 1, characterized in that at least one input/output unit is connected to the evaluation unit (9).

10. The control device (7) according to claim 9, characterized in that authentication data can be input into the evaluation unit (9) via the input/output unit.

11. The control device (7) according to claim 9, characterized in that an operating mode to be selected can be input via the input/output unit.

12. The control device (7) according to claim 11, characterized in that the operating mode that was input can be verified in the evaluation unit (9).

13. The control device (7) according to claim 12, characterized in that an operating mode that was verified in the evaluation unit (9) and released is output to the controller via the output stage (8).

14. The control device (7) according to claim 1, characterized in that the or multiple acquisition units (17a, 17b) are designed for a data transfer.

15. The control device (7) according to claim 1, characterized in that the evaluation unit (9) has at least one interface (13) for connecting additional components.
